(19) United States
(12) Patent Application Publication
(10) Pub. No.: US 2026/0246214 A1
(43) Pub. Date: Aug. 20, 2026

(54) COAXIAL CONNECTOR CONNECTION STRUCTURE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yasunori ASANO, Mie (JP); Yutaka KOBAYASHI, Mie (JP); Shinji TANAKA, Mie (JP); Hiroyuki ISHIGURE, Mie (JP)

(21) Appl. No.: 19/489,588

(22) PCT Filed: May 29, 2024
(86) PCT No.: PCT/JP2024/019778

§ 371 Date: Dec. 3, 2025

(30) Foreign Application Priority Data
Jun. 7, 2023 (JP) 2023-093730

(51) Int. Cl. H01R 24/38; H01R 12/53; H01R 13/05; H01R 103/00

(52) U.S. Cl. CPC H01R 24/38; H01R 12/53; H01R 13/052; H01R 2103/00; H01R 2201/18

(57) ABSTRACT

A coaxial connector connection structure is for connecting a first coaxial connector and a second coaxial connector. The first coaxial connector includes a first inner conductor, a first outer conductor and a first dielectric. The second coaxial connector includes a second inner conductor, a second outer conductor and a second dielectric. When it is assumed that an overlapping part of the first inner conductor and the second inner conductor in a connection direction is an inner overlapping part and an overlapping part of the first outer conductor and the second outer conductor in the connection direction is an outer overlapping part with the both coaxial connectors connected, both the first dielectric and the second dielectric are located to avoid both the inner overlapping part and the outer overlapping part.

### TECHNICAL FIELD

The present disclosure relates to a coaxial connector connection structure.

### BACKGROUND

Patent Document 1 discloses a connection structure of a coaxial connector and a mating coaxial connector. In a connected state of the both connectors, a housing movable portion is located between a connecting portion of a center contact and a resilient contact piece of an outer contact. Further, in the connected state of the both connectors, an insulator is facing the housing movable portion.

### PRIOR ART DOCUMENT

### Patent Document

Patent Document 1: JP 2016-062661 A

### SUMMARY OF THE INVENTION

### Problems to be Solved

The housing movable portion and the insulator of Patent Document 1 are thought to function as dielectrics between an inner conductor and an outer conductor. Further, in Patent Document 1, the shape of the connection structure is thought to be so designed that desired communication performance can be obtained, assuming a configuration in which the insulator approaches the housing movable portion immediately near the housing movable portion.

However, if the position of the mating coaxial connector deviates with respect to the coaxial connector, an air layer is assumed to be present between the housing movable portion and the insulator. In this case, communication performance in the connection structure of the coaxial connector and the mating coaxial connector may possibly deviate from a design value.

Accordingly, the present disclosure aims to enable stable communication performance to be obtained even if a connected position of a second coaxial connector to a first coaxial connector deviates.

### Means to Solve the Problem

The present disclosure is directed to a coaxial connector connection structure for connecting a first coaxial connector and a second coaxial connector, the first coaxial connector including a first inner conductor, a first outer conductor surrounding an outer peripheral side of the first inner conductor and a first dielectric located between the first inner conductor and the first outer conductor, the second coaxial connector including a second inner conductor, a second outer conductor surrounding an outer peripheral side of the second inner conductor and a second dielectric located between the second inner conductor and the second outer conductor, and when it is assumed that an overlapping part of the first inner conductor and the second inner conductor in a connection direction of the first coaxial connector and the second coaxial connector is an inner overlapping part and an overlapping part of the first outer conductor and the second outer conductor in the connection direction is an outer overlapping part with the first coaxial connector and the second coaxial connector connected, both the first dielectric and the second dielectric being located to avoid both the inner overlapping part and the outer overlapping part in the connection direction.

### Effect of the Invention

According to the present disclosure, stable communication performance is obtained even if a connected position of a second coaxial connector to a first coaxial connector deviates.

### BRIEF DESCRIPTION OF THE DRAWINGS

FIG. 1 is a perspective view showing a device according to an embodiment.

FIG. 2 is a section along II-II of FIG. 1.

FIG. 3 is a perspective view showing a coaxial connector connection structure.

FIG. 4 is an exploded perspective view showing the connection structure.

FIG. 5 is an enlarged section of FIG. 3.

FIG. 6 is a perspective view partly in section showing a fixed location of a first inner conductor to a first dielectric.

FIG. 7 is a perspective view showing the coaxial connector connection structure in another state.

FIG. 8 is a perspective view showing the coaxial connector connection structure in still another state.

### DETAILED DESCRIPTION TO EXECUTE THE INVENTION

### Description of Embodiments of Present Disclosure

First, embodiments of the present disclosure are listed and described.

The coaxial connector connection structure of the present disclosure is as follows.

(1) The coaxial connector connection structure of the present disclosure is for connecting a first coaxial connector and a second coaxial connector, the first coaxial connector including a first inner conductor, a first outer conductor surrounding an outer peripheral side of the first inner conductor and a first dielectric located between the first inner conductor and the first outer conductor, the second coaxial connector including a second inner conductor, a second outer conductor surrounding an outer peripheral side of the second inner conductor and a second dielectric located between the second inner conductor and the second outer conductor, and when it is assumed that an overlapping part of the first inner conductor and the second inner conductor in a connection direction of the first coaxial connector and the second coaxial connector is an inner overlapping part and an overlapping part of the first outer conductor and the second outer conductor in the connection direction is an outer overlapping part with the first coaxial connector and the second coaxial connector connected, both the first dielectric and the second dielectric being located to avoid both the inner overlapping part and the outer overlapping part in the connection direction.

In this case, both the first and second dielectrics are located to avoid both the inner and outer overlapping parts in the connection direction. Thus, in the coaxial connector connection structure, the first and second coaxial connectors can be designed to obtain desired communication performance on the premise of the presence of air between the inner and outer overlapping parts. In this case, even if a connected position of the second coaxial connector to the first coaxial connector deviates, only a length of an air present part varies in the connection direction. Stable communication performance is obtained as compared to the case where each coaxial connector is designed, assuming the presence of a dielectric in most of the inner and outer overlapping parts.

(2) In the coaxial connector connection structure of (1), the first dielectric may be located closer to a base end side of each of the first inner conductor and the first outer conductor than both the inner overlapping part and the outer overlapping part in the connection direction, and the second dielectric may be located closer to a base end side of each of the second inner conductor and the second outer conductor than both the inner overlapping part and the outer overlapping part in the connection direction.

In this case, the first inner conductor and the first outer conductor can be kept in a fixed positional relationship on a side closer to the base end of each of the first inner conductor and the first outer conductor than both the inner and outer overlapping parts. The second inner conductor and the second outer conductor can be kept in a fixed positional relationship on a side closer to the base end of each of the second inner conductor and the second outer conductor than both the inner and outer overlapping parts. Thus, a coaxial state of the coaxial connectors is easily kept and communication performance is stabilized while an air layer is provided.

(3) In the coaxial connector connection structure of (1) or (2), an allowable maximum length may be set in the connection direction for each of the inner overlapping part and the outer overlapping part, and both the first dielectric and the second dielectric may be located to avoid both the inner overlapping part and the outer overlapping part, each having reached the allowable maximum length.

It is assumed that each of the inner and outer overlapping parts reaches the allowable maximum length if the second coaxial connector is excessively connected to the first coaxial connector within a tolerance range. Even in this case, stable communication performance is obtained since air is present between the inner and outer overlapping parts.

(4) In the coaxial connector connection structure of any one of (1) to (3), the first inner conductor may include a first inner conductor tube portion and a first inner conductor resilient piece projecting from a tip of the first inner conductor tube portion, the second inner conductor may include a second inner conductor tube portion to be resiliently contacted by the first inner conductor resilient piece, the first dielectric may surround a base end side part of the first inner conductor tube portion, and the first dielectric may be located away from the tip of the first inner conductor tube portion toward a base end side of the first inner conductor tube portion by half the projecting length of the first inner conductor resilient piece or more in the connection direction.

In this case, the first dielectric is easily located to avoid each of the inner and outer overlapping parts.

(5) In the coaxial connector connection structure of any one of (1) to (4), the second inner conductor may include a second inner conductor tube portion and a second inner conductor extended tube portion, the second outer conductor may include a second outer conductor tube portion and a second outer conductor extended tube portion, the second inner conductor tube portion may be a part to be connected to the first inner conductor, the second outer conductor tube portion may be a part to be connected to the first outer conductor, the second outer conductor tube portion may be coaxially arranged around the second inner conductor tube portion, and the second dielectric may be arranged between the second inner conductor extended tube portion and the second outer conductor extended tube portion while avoiding a gap between the second inner conductor tube portion and the second outer conductor tube portion in the connection direction.

In this case, air is easily arranged between the inner and outer overlapping parts.

(6) In the coaxial connector connection structure of any one of (1) to (4), the first inner conductor may include a first inner conductor tube portion and a first inner conductor resilient piece projecting from a tip of the first inner conductor tube portion, the first outer conductor may include a first outer conductor tube portion and a first outer conductor resilient piece projecting from a tip of the first outer conductor tube portion, the second inner conductor may include a second inner conductor tube portion to be resiliently contacted by the first inner conductor resilient piece, the second outer conductor may include a second outer conductor tube portion to be resiliently contacted by the first outer conductor resilient piece, the first inner conductor resilient piece may resiliently contact an inner peripheral surface of the second inner conductor tube portion, and the first outer conductor resilient piece may resiliently contact an outer peripheral surface of the second outer conductor tube portion.

In this way, the presence of the resilient pieces is suppressed between the second inner conductor tube portion and the second outer conductor tube portion. In this way, communication performance in the coaxial connector connection structure can be designed on the basis of the second inner conductor tube portion and the second outer conductor tube portion and this designing is easily performed. Further, since the second inner conductor tube portion and the second outer conductor tube portion are constituent parts of the second coaxial connector, a positional relationship of the second inner conductor tube portion and the second outer conductor tube portion is easily kept constant. Thus, more stable communication performance is obtained.

(7) In the coaxial connector connection structure of any one of (1) to (6), the first inner conductor may include a positioning piece projecting to an outer peripheral side from an outer peripheral surface of a base end part of the first inner conductor and extending along a center axis of the first inner conductor, the first dielectric may be formed with an insertion hole, the base end part of the first inner conductor being inserted into the insertion hole, and a positioning groove, the positioning piece being fit into the positioning groove, and the first inner conductor may be inserted and fixed in the first dielectric by fitting the positioning piece into the positioning groove with the base end part of the first inner conductor inserted in the insertion hole.

In this way, the first inner conductor is firmly fixed in the first dielectric.

(8) In the coaxial connector connection structure of (7), a retaining projection to be hooked to the first dielectric inside the positioning groove may be formed on a projecting end part of the positioning piece.

In this way, the retaining projection on the projecting end part of the positioning piece is hooked to the first dielectric inside the positioning groove, whereby the first inner conductor is less likely to come out from the first dielectric.

(9) In the coaxial connector connection structure of (7) or (8), a holding annular protrusion annularly projecting toward a tip side of the first inner conductor may be formed in a part of the first dielectric surrounding the insertion hole.

In this case, since the first inner conductor can be held also by the holding annular protrusion, the first inner conductor is more firmly held.

(10) In the coaxial connector connection structure of any one of (7) to (9), an outer peripheral annular protrusion annularly projecting toward a tip side of the first inner conductor may be formed on an outer peripheral part of the first dielectric on the first outer conductor side.

In this case, the outer peripheral annular protrusion contacts the first outer conductor, whereby the posture of the first outer conductor is easily stabilized with respect to the first dielectric. In this way, a positional relationship of the first inner conductor and the second outer conductor is stabilized and communication performance is easily stabilized.

(11) In the coaxial connector connection structure of any one of (1) to (10), the first coaxial connector may be a board side coaxial connector to be fixed to a circuit board, and the second coaxial connector may be a relay coaxial connector for relaying and connecting the first coaxial connector and a third coaxial connector.

If the second coaxial connector is the relay coaxial connector for relaying and connecting the first coaxial connector and the third coaxial connector as just described, the position of the second coaxial connector with respect to the first coaxial connector may possibly vary according to a positional relationship of the first and third coaxial connectors. In such a case, stable communication performance is obtained between the first and second coaxial connectors.

### Details of Embodiment of Present Disclosure

A specific example of a coaxial connector connection structure of the present disclosure is described below with reference to the drawings. Note that the present disclosure is not limited to these illustrations, but is represented by claims and intended to include all changes in the scope of claims and in the meaning and scope of equivalents.

### Embodiment

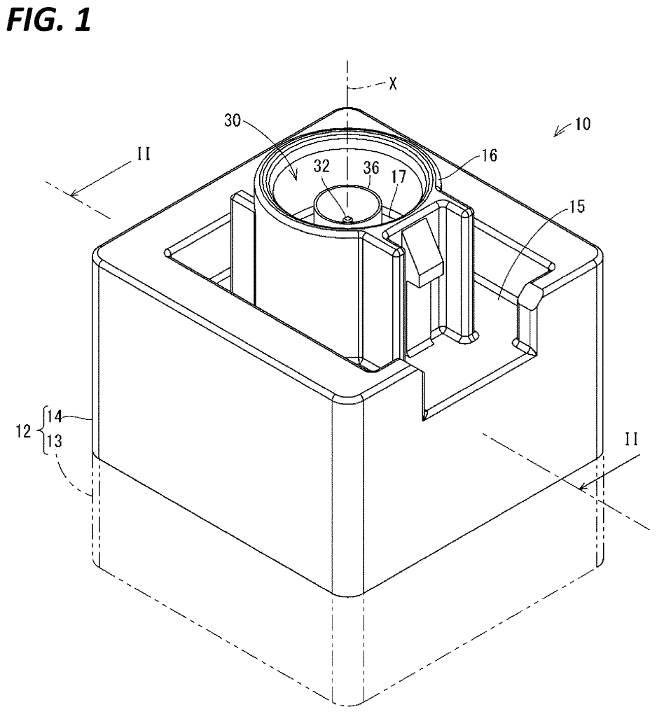

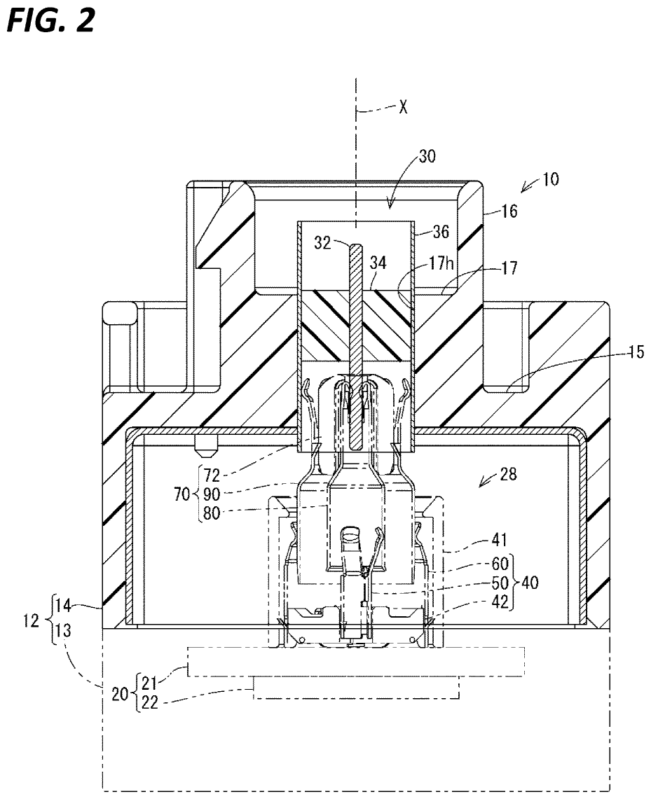

Hereinafter, a coaxial connector connection structure according to an embodiment is described. FIG. 1 is a perspective view showing a device 10 provided with a coaxial connector connection structure 28. FIG. 2 is a section along II-II of FIG. 1.

### Concerning Overall Configuration of Device

The device 10 is, for example, a camera device. The camera device is, for example, an in-vehicle device. The device 10 may not be a camera device.

The device 10 is provided with a case 12, an electrical component 20 and an external connection coaxial connector 30. The electrical component 20 is accommodated in the case 12. The external connection coaxial connector 30 is a connector for connecting the electrical component 20 and an external electrical component. For example, the external connection coaxial connector 30 is a connector, to which a cable connected to the external electrical component is connected.

The case 12 is provided with a first case 13 and a second case 14. The first and second cases 13, 14 are, for example, made of resin. By uniting the first and second cases 13, 14, the case 12 in the form of a rectangular parallelepiped box for accommodating the electrical component 20 is configured. If the device 10 is a camera device, it is assumed that the first case 13 includes a lens or window for imaging, and the second case 14 includes the external connection coaxial connector 30.

More specifically, a holding tube portion 16 projects on a bottom portion 15 of the case 12. The holding tube portion 16 is a hollow cylinder and projects outward from a central part of the bottom portion 15. An inner opening of the holding tube portion 16 is open to the inside of the second case 14, and an outer opening of the holding tube portion 16 is open to the outside of the second case 14. A holding/partitioning portion 17 is formed in an intermediate part in a direction along a center axis X of the holding tube portion 16. In this embodiment, the holding/partitioning portion 17 is formed in the intermediate part in the direction along the center axis X of the holding tube portion 16 and at a position near the inner opening. The holding/partitioning portion 17 partitions between a space on the inner opening side and a space on the outer opening side in the holding tube portion 16. The holding/partitioning portion 17 is formed with a holding hole 17h, and the external connection coaxial connector 30 is inserted and held in the holding hole 17h.

The external connection coaxial connector 30 is provided with an external connection inner conductor 32, an external connection dielectric 34 and an external connection outer conductor 36.

The external connection inner conductor 32 is in the form of an elongated bar and made of an electrically conductive material such as metal. The external connection inner conductor 32 is an example of a pin-like opposite mating inner conductor to be inserted and connected to a second inner conductor 80 to be described later. The external connection dielectric 34 is formed of an insulator such as resin and surrounds the external connection inner conductor 32. The external connection outer conductor 36 is made of an electrically conductive material such as metal. The external connection outer conductor 36 is formed into a tubular shape surrounding the external connection dielectric 34. The external connection outer conductor 36 is an example of a mating outer conductor to be connected to a second outer conductor 90.

The electrical component 20 is, for example, a mounting board having an electronic component mounted on a board. If the device 10 is a camera device, the electrical component 20 is assumed to include a circuit board 21 and an imaging element 22 mounted on the circuit board 21. The imaging element 22 faces the lens or window for imaging of the first case 13 and images an outside view by turning the lens or window. The side of the first case 13, toward which the imaging element 22 is facing, may be referred to as a front side, and the side of the second case 14 opposite to the front side may be referred to as a rear side below.

The coaxial connector connection structure 28 is incorporated into the device 10. The coaxial connector connection structure 28 is a connection structure of a first coaxial connector 40 and a second coaxial connector 70.

In this embodiment, the first coaxial connector 40 is located on a surface of the circuit board 21 opposite to the imaging element 22. The first coaxial connector 40 is an example of a board side coaxial connector to be fixed to the circuit board 21.

The first coaxial connector 40 includes a first inner conductor 50, a first outer conductor 60 surrounding an outer peripheral side of the first inner conductor 50 and a first dielectric 42 located between the first inner conductor 50 and the first outer conductor 60.

The first dielectric 42 surrounds the first inner conductor 50. The first dielectric 42 is formed of an insulator. The first outer conductor 60 surrounds the first dielectric 42. A base end part of the first inner conductor 50 and that of the first outer conductor 60 are fixed to the circuit board 21 by soldering or the like. In this way, the first inner conductor 50 and the first outer conductor 60 are electrically connected to a circuit of the circuit board 21 and fixed in a state projecting from the circuit board 21. The first coaxial connector 40 projects from the circuit board 21 toward the external connection coaxial connector 30.

The second coaxial connector 70 is connected to the first coaxial connector 40. The second coaxial connector 70 includes the second inner conductor 80, the second outer conductor 90 surrounding an outer peripheral side of the second inner conductor 80 and a second dielectric 72 located between the second inner conductor 80 and the second outer conductor 90. The second dielectric 72 surrounds the second inner conductor 80. The second dielectric 72 is formed of an insulator. The second outer conductor 90 surrounds the second dielectric 72. With the first inner conductor 50 inserted and connected to the second inner conductor 80 and the second outer conductor 90 inserted and connected to the first outer conductor 60, the second coaxial connector 70 is connected to the first coaxial connector 40. The second coaxial connector 70 projects further toward the external connection coaxial connector 30 from the first coaxial connector 40. The second coaxial connector 70 relays and connects the first coaxial connector 40 and the external connection coaxial connector 30. The second coaxial connector 70 is so connected to the first coaxial connector 40 and the external connection coaxial connector 30 as to be capable of changing a posture.

The external connection coaxial connector 30 may be grasped as a third coaxial connector, and the second coaxial connector 70 may be grasped as a relay coaxial connector for relaying and connecting the first coaxial connector 40 and the third coaxial connector.

The external connection coaxial connector 30 is provided on the side of the second case 14, i.e. on a rear side of the case 12. The second coaxial connector 70 is connected to the external connection coaxial connector 30 in the case 12. A cable from outside is connected to the external connection coaxial connector 30, whereby an external electrical component as a connection destination of this cable and the electrical component 20 in the case 12 are electrically connected.

The circuit board 21 is supported at a fixed position in the case 12. In design, the position of the first coaxial connector 40 with respect to the external connection coaxial connector 30 is set to be a fixed position. However, the position of the first coaxial connector 40 with respect to the external connection coaxial connector 30 may possibly deviate from a design position within a tolerance range.

In this embodiment, an insertion amount of the second coaxial connector 70 into the first coaxial connector 40 can be adjusted within a range that the first inner conductor 50 and the second inner conductor 80 can be kept in electrical contact and the first outer conductor 60 and the second outer conductor can be kept in electrical contact. Further, the second coaxial connector 70 can be inserted and connected in an inclined state to the first coaxial connector 40 and the external connection coaxial connector 30. In this way, even if a distance of the external connection 30 from the first coaxial connector 40 varies during an assembly operation or in a completed state of the device 10, this distance change can be absorbed by adjusting the insertion amount of the second coaxial connector 70 into the first coaxial connector 40. Further, even if the external connection coaxial connector 30 deviates from a position facing the first coaxial connector 40 on the same axis, this position deviation is absorbed by the second coaxial connector 70 being inclined with respect to the first coaxial connector 40 and the external connection coaxial connector 30.

### Concerning Coaxial Connector Connection Structure

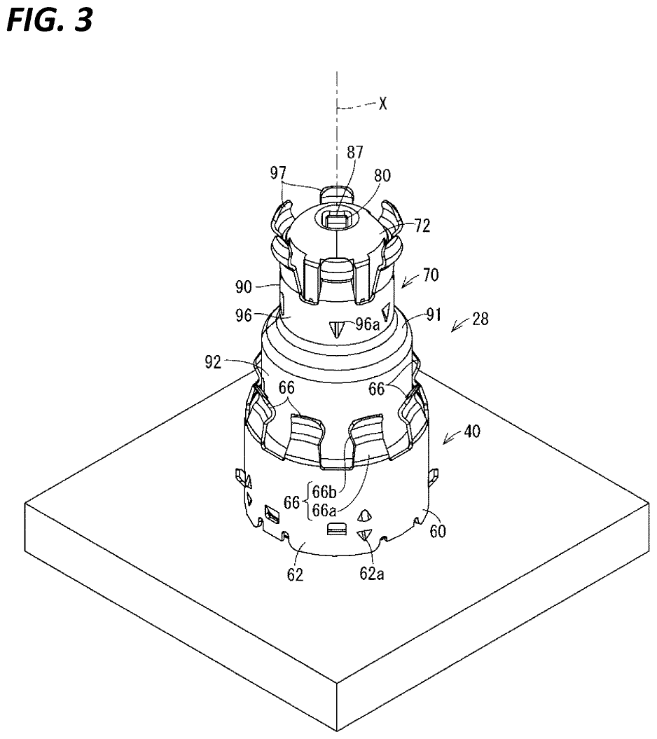

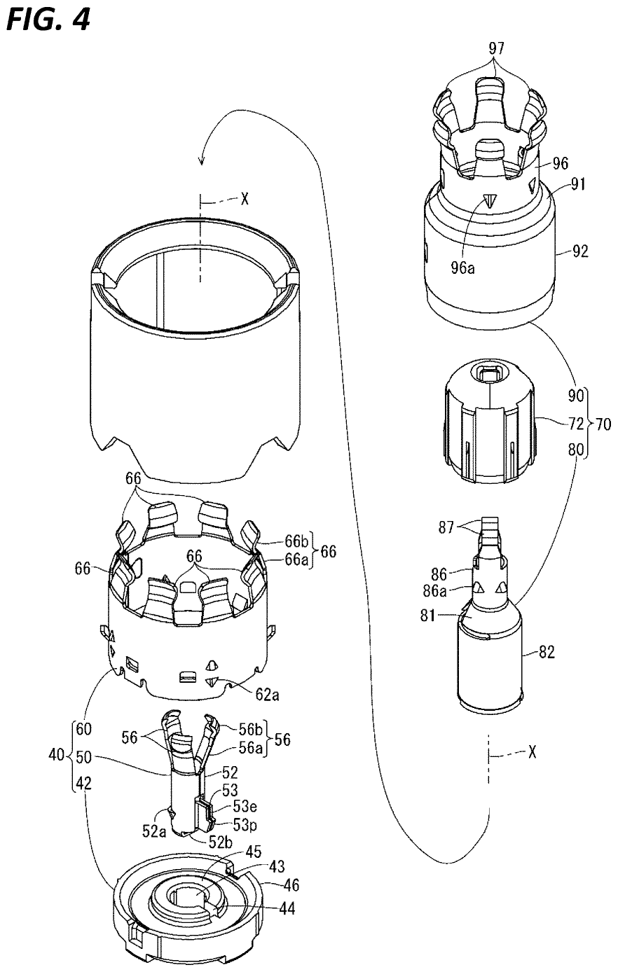

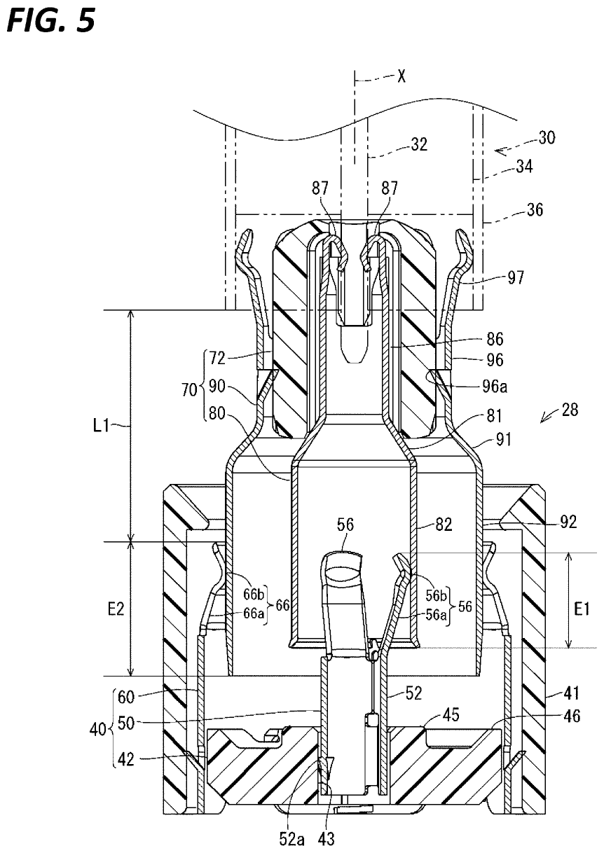

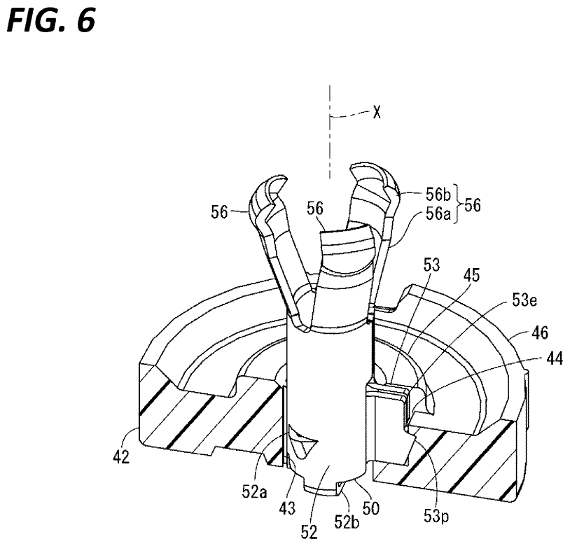

The coaxial connector connection structure 28 is more specifically described. FIG. 3 is a perspective view showing the coaxial connector connection structure 28. FIG. 4 is an exploded perspective view showing the connection structure. FIG. 5 is an enlarged section of FIG. 3. FIG. 6 is a perspective view partly in section showing a fixed location of the first inner conductor 50 to the first dielectric 42.

After each of the first coaxial connector 40 and the second coaxial connector 70 is specifically described, the connection structure 28 is more specifically described, focusing on a positional relationship of the both coaxial connectors 40, 70.

### Concerning First Coaxial Connector

As described above, the first coaxial connector 40 includes the first inner conductor 50, the first outer conductor 60 and the first dielectric 42.

The first inner conductor 50 is an elongated electrically conductive member. In this embodiment, the first inner conductor 50 may be formed by press-working a metal plate. Note that a first inner conductor may be formed by cutting a metal material.

More specifically, the first inner conductor 50 includes a first inner conductor tube portion 52 and first inner conductor resistance pieces 56.

The first inner conductor tube portion 52 is formed into a tubular shape, more specifically a hollow cylindrical shape. A base end part of the first inner conductor 50 is accommodated and held in the first dielectric 42. Note that, in the first coaxial connector 40, a tip is an end on a side where the second coaxial connector 70 is connected, and a base end is an end opposite to the tip, here an end facing the circuit board 21.

A positioning piece 53 is formed to project to an outer peripheral side from a circumferential part in a base end part of the first inner conductor tube portion 52. The positioning piece 53 is a plate-like part along a center axis of the first inner conductor tube portion 52 and, in this embodiment, a rectangular plate-like part. The positioning piece 53 is configured by overlapping two plate-like parts. In this embodiment, the first inner conductor tube portion 52 is formed by press-working a plate-like part into a tube. Plate-like parts project to the outer peripheral side respectively from two edge parts adjacent at a joint of the tube, and the positioning piece 53 is formed by overlapping these two plate-like parts.

A retaining projection 53p to be hooked to the bottom of a positioning groove 44 of the first dielectric 42 is formed on a projecting end part 53e of the positioning piece 53. The retaining projection 53p is formed into a shape to be hooked to the bottom of the positioning groove 44 to make the detachment of the first inner conductor tube portion 52 from the first dielectric 42 toward the tip side difficult. Here, the retaining projection 53p is in the form of a triangular plate. An edge of the retaining projection 53p on the tip side of the first inner conductor tube portion 52 is more inclined with respect to the center axis X than an edge of the retaining projection 53p on the base end side of the first inner conductor tube portion 52. Thus, the retaining projection 53p is easily press-fit into the positioning groove 44 toward the base end side of the first inner conductor tube portion 52 and can be made difficult to come out toward the tip side of the first inner conductor tube portion 52. The above positioning piece 53 and retaining projection 53p may be omitted.

The first inner conductor tube portion 52 may be formed with a locking piece 52a to be hooked to the inner peripheral surface of the first dielectric 42 when being press-fit into the first dielectric 42. A projecting piece 52b used for soldering may be provided to extend along a principal surface of the circuit board 21 on the base end of the first inner conductor tube portion 52.

The first inner conductor resistance pieces 56 project from the tip of the first inner conductor tube portion 52. In this embodiment, a plurality of (here, three) first inner conductor resistance pieces 56 extend from the tip of the first inner conductor tube portion 52 while being spaced apart in a circumferential direction. Preferably, the plurality of first inner conductor resistance pieces 56 are located at equal intervals around a center axis X of the first inner conductor tube portion 52.

The first inner conductor resistance piece 56 includes an inclined portion 56a inclined outward from the tip of the first inner conductor tube portion 52 and a curved portion 56b connected to a tip part of the inclined portion 56a and having a curved shape convex outward.

If the plurality of first inner conductor resistance pieces 56 are inserted into the second inner conductor 80, outward facing top parts of the curved portions 56b are resiliently pressed against the inner peripheral surface of the second inner conductor 80 while the inclined portions 56a are resiliently deformed inward. In this way, the first inner conductor 50 is kept in a state electrically connected to the second inner conductor 80.

Note that the number of the resilient pieces may be two, four or more.

The first dielectric 42 is made of resin or the like into a disk shape. A maximum thickness of the first dielectric 42 is smaller than a length of the first inner conductor tube portion 52. The first dielectric 42 is, for example, a molded resin component.

An insertion hole 43, into which the base end part of the first inner conductor 50, more specifically the base end part of the first inner conductor tube portion 52, is inserted, is formed in a center of the first dielectric 42. Further, the positioning groove 44 is formed, into which the positioning piece 53 is fit. The positioning groove 44 is in the form of a groove recessed toward an outer peripheral side from a circumferential part of the insertion hole 43 and extending along the center axis X.

By inserting the first inner conductor tube portion 52 into the insertion hole 43, the first inner conductor 50 is inserted and held in the first dielectric 42. Preferably, the first inner conductor tube portion 52 is press-fit and held in the insertion hole 43.

If a first inner conductor is a cutting component, the first inner conductor is easily firmly held in a first dielectric by the above press-fit structure. If the first inner conductor 50 is a press-worked component of a metal plate, the positioning piece 53 is fit into the positioning groove 44 to enhance holding strength. The inner peripheral surface of the positioning groove 44 clamps the positioning piece 53, whereby it becomes easier to firmly hold the first inner conductor 50 by the first dielectric 42.

Further, the retaining projection 53p of the positioning piece 53 is hooked to bite into the bottom of the positioning groove 44, whereby the first inner conductor 50 is less likely to come out from the first dielectric 42 and the first inner conductor 50 is more firmly held.

Further, a holding annular protrusion 45 annularly projecting toward the tip side of the first inner conductor 50 is formed in a part of the first dielectric 42 surrounding the insertion hole 43. The holding annular protrusion 45 holds the first inner conductor tube portion 52, whereby the first inner conductor 50 is more firmly held and the first inner conductor 50 is hardly inclined with respect to the first dielectric 42.

The outer peripheral surface of the first dielectric 42 is formed into a short cylindrical surface insertable into an inner peripheral part of the first outer conductor 60. An outer peripheral annular protrusion 46 annularly projecting toward the tip side of the first inner conductor 50 is formed in an outer peripheral part of the first dielectric 42 on the side of the first outer conductor 60. The outer peripheral surface of the first dielectric 42 is formed to be wide in the direction of the center axis X by the outer peripheral annular protrusion 46. Thus, the outer peripheral surface of the first dielectric 42 can face the inner peripheral surface of the first outer conductor 60 in a wide area. In this way, it is easy to firmly hold the first dielectric 42 with respect to the first outer conductor 60 and the first outer conductor 60 is hardly inclined with respect to the first dielectric 42. In this way, a coaxial positional relationship of the first inner conductor 50 and the first outer conductor 60 is easily kept.

The first outer conductor 60 is made of an electrically conductive material such as metal and surrounds the first dielectric 42. Thus, the first dielectric 42 is a tubular member interposed between the first inner conductor 50 and the first outer conductor 60. The first outer conductor 60 is, for example, formed, such as by press-working a metal plate.

In this embodiment, the first outer conductor 60 includes a first outer conductor tube portion 62 and first outer conductor resilient pieces 66 projecting from the tip of the first outer conductor tube portion 62.

The first outer conductor tube portion 62 is formed into a tubular shape in which the first dielectric 42 can be arranged, more specifically a hollow cylindrical shape. The first dielectric 42 is accommodated and held in a base end part of the first outer conductor tube portion 62.

The first outer conductor tube portion 62 may be formed with locking pieces 62a to be hooked to the outer peripheral surface of the first dielectric 42 when the first dielectric 42 is press-fit.

The first outer conductor resilient pieces 66 project from the tip of the first outer conductor tube portion 62. In this embodiment, a plurality of (here, eight) first outer conductor resilient pieces 66 extend from the tip of the first outer conductor tube portion 62 while being spaced apart in a circumferential direction. Preferably, the plurality of first outer conductor resilient pieces 66 are located at equal intervals around a center axis X of the first outer conductor tube portion 62.

The first outer conductor resilient piece 66 includes an inclined portion 66a inclined inward from the tip of the first outer conductor tube portion 62 and a curved portion 66b connected to a tip part of the inclined portion 66a and having a curved shape convex inward.

If the plurality of first outer conductor resilient pieces 66 are externally fit to the second outer conductor 90, inward facing top parts of the curved portions 66b are resiliently pressed against the outer peripheral surface of the second outer conductor 90 while the inclined portions 66a are resiliently deformed outward. In this way, the first outer conductor 60 is kept in a state electrically connected to the second outer conductor 90.

Note that the number of the resilient pieces may be seven or less or nine or more.

In the direction of the center axis X, a length of the first outer conductor tube portion 62 is larger than a thickness of the first dielectric 42. Further, in this embodiment, the length of the first outer conductor tube portion 62 is larger than that of the first inner conductor 50. Further, the base end of the first outer conductor resilient piece 66 is located more away from the first dielectric 42 than that of the first inner conductor resistance piece 56. Furthermore, the tip of the first outer conductor resilient piece 66 is located more away from the first dielectric 42 than that of the first inner conductor resistance piece 56. However, the curved portions 56b, 66b can contact the second inner conductor 80 or the second outer conductor 90 at the same position in the center axis X.

The first coaxial connector 40 may be surrounded by a tubular connector holder 41. The connector holder 41 is a member made of resin or the like and functions to suppress contact with other members by surrounding the first coaxial connector 40.

### Concerning Second Coaxial Connector

As described above, the second coaxial connector 70 is provided with the second inner conductor 80, the second outer conductor 90 and the second dielectric 72.

The second inner conductor 80 is an elongated electrically conductive member. In this embodiment, the second inner conductor 80 is formed by press-working a metal plate. More specifically, the second inner conductor 80 includes a second inner conductor tube portion 82 and a second inner conductor extended tube portion 86.

The second inner conductor tube portion 82 is formed into a tubular shape, more specifically a hollow cylindrical shape. An opening end of the second inner conductor tube portion 82 is facing toward the first coaxial connector 40. The second inner conductor tube portion 82 is a part to be connected to the first inner conductor 50.

More specifically, the second inner conductor tube portion 82 is a tube elongated along the center axis X. An inner diameter of the second inner conductor tube portion 82 is smaller than an outer diameter of a virtual circle connecting the top parts of the plurality of first inner conductor resistance pieces 56. The plurality of first inner conductor resistance pieces 56 can resiliently contact the inner peripheral surface of the second inner conductor tube portion 82 while being resiliently deformed inward.

In the direction of the center axis X, the second inner conductor tube portion 82 is longer than the first inner conductor resilient pieces 56. In the direction of the center axis X, the first and second inner conductors 50, 80 can be connected by top parts of the curved portions 56b of the first inner conductor resilient pieces 56 contacting the inner peripheral surface of the second inner conductor tube portion 82 at arbitrary positions. In this way, position deviations of the first and second inner conductors 50, 80 in the direction of the center axis X can be dealt with.

The second inner conductor extended tube portion 86 is located on a side opposite to the first coaxial connector 40 with respect to the second inner conductor tube portion 82. In this embodiment, the second inner conductor extended tube portion 86 is thinner than the second inner conductor tube portion 82. The second inner conductor extended tube portion 86 is connected to the second inner conductor tube portion 82 via a tapered portion 81. The tapered portion 81 is a part having a tapered shape gradually thinned from the second inner conductor tube portion 82 toward the second inner conductor extended tube portion 86. A second inner conductor extended tube portion may be connected to a second inner conductor tube portion via a step portion.

The second inner conductor extended tube portion 86 may include resilient pieces 87 projecting toward the tip side. The resilient piece 87 is configured to be resiliently deformable in an in-out direction. The external connection inner conductor 32 is inserted between two resilient pieces 87 from the tip sides of the two resilient pieces 87. The external connection inner conductor 32 is sandwiched by the two resilient pieces 87, whereby the second inner conductor 80 is connected to the external connection inner conductor 32.

The second inner conductor extended tube portion 86 may be formed with partial locking pieces 86a lockable to the second dielectric 72.

The second dielectric 72 is made of resin or the like. The second dielectric 72 is, for example, a molded resin component.

The second dielectric 72 is formed into a tubular shape capable of accommodating at least a part of the second inner conductor 80. In this embodiment, the second dielectric 72 is formed into a hollow cylindrical shape. The second inner conductor extended tube portion 86 is accommodated into the second dielectric 72. The internal space of the second inner conductor extended tube portion 86 is formed in such a size that a base end part of the second inner conductor extended tube portion 86 can be press-fit and held therein and the resilient pieces 87 can be allowed to be resiliently deformed in the in-out direction.

One end of the second dielectric 72 contacts the tapered portion 81, whereby the second dielectric 72 can be positioned with respect to the second inner conductor 80. The second inner conductor tube portion 82 extends further toward the first coaxial connector 40 than the second dielectric 72.

The second outer conductor 90 is arranged on an outer peripheral side of the second dielectric 72. The second outer conductor 90 is made of an electrically conductive material such as metal and surrounds the second dielectric 72. The second outer conductor 90 is, for example, formed by press-working a metal plate.

The second outer conductor 90 includes a second outer conductor tube portion 92 and a second outer conductor extended tube portion 96.

The second outer conductor tube portion 92 is formed into a tubular shape, more specifically a hollow cylindrical shape. An opening end of the second outer conductor tube portion 92 is facing toward the first coaxial connector 40. The second outer conductor tube portion 92 is a part to be connected to the first outer conductor 60.

The second outer conductor tube portion 92 is located on an outer peripheral side of the second inner conductor tube portion 82 while being spaced apart from the second inner conductor tube portion 82. An outer diameter of the second outer conductor tube portion 92 is larger than an outer diameter of a virtual circle connecting the top parts of the plurality of first outer conductor resilient pieces 66. The plurality of first outer conductor resilient pieces 66 can resiliently contact the outer peripheral surface of the second outer conductor tube portion 92 while being resiliently deformed outward.

In the direction of the center axis X, the second outer conductor tube portion 92 is longer than the first outer conductor resilient pieces 66. In the direction of the center axis X, the first and second outer conductors 60, 90 can be connected by top parts of the curved portions 66b of the first outer conductor resilient pieces 66 contacting the outer peripheral surface of the second outer conductor tube portion 92 at arbitrary positions. In this way, position deviations of the first and second outer conductors 60, 90 in the direction of the center axis X can be dealt with.

The second outer conductor extended tube portion 96 is located on a side opposite to the first coaxial connector 40 with respect to the second outer conductor tube portion 92. In this embodiment, the second outer conductor extended tube portion 96 is thinner than the second outer conductor tube portion 92. The second outer conductor extended tube portion 96 is connected to the second outer conductor tube portion 92 via a tapered portion 91. The tapered portion 91 is a part having a tapered shape gradually thinned from the second outer conductor tube portion 92 toward the second outer conductor extended tube portion 96. A second outer conductor extended tube portion may be connected to a second outer conductor tube portion via a step portion.

The second outer conductor extended tube portion 96 may include resilient pieces 97 projecting toward the tip side. The resilient piece 97 is configured to be resiliently deformable in the in-out direction. The external connection outer conductor 36 is externally fit to the outer peripheries of the plurality of resilient pieces 97 from the tip sides of the plurality of resilient pieces 97. The second outer conductor 90 is connected to the external connection outer conductor 36 by resiliently pressing the plurality of resilient pieces 97 against the inner peripheral surface of the external connection outer conductor 36.

The second outer conductor extended tube portion 96 may be formed with partial locking pieces 96a lockable to the second dielectric 72.

### Concerning Connection Structure

Arrangement positions of the first and second dielectrics 42, 72 are described on the basis of a state where the first and second coaxial connectors 40, 70 are connected.

The connected sate of the first and second coaxial connectors 40, 70 is assumed. Here, it is assumed that the first coaxial connector 40 and the external connection coaxial connector 30 are separated by a distance L1 (see FIG. 5).

A connection direction of the first and second coaxial connectors 40, 70 is along the centers axis X of the first and second coaxial connectors 40, 70. In the direction of the center axis X, an overlapping part of the first and second inner conductors 50, 80 is assumed as an inner overlapping part E1 (see FIG. 5). In the direction of the center axis X, an overlapping part of the first and second outer conductors 60, 90 is assumed as an outer overlapping part E2 (see FIG. 5).

The first and second dielectrics 42, 72 are both located to avoid both the inner overlapping part E1 and the outer overlapping part E2 in the connection direction. Preferably, the first dielectric 42 is located closer to the base end side of each of the first inner conductor 50 and the first outer conductor 60 than both the inner overlapping part E1 and the outer overlapping part E2. Further, preferably, the second dielectric 72 is located closer to the base end side of each of the second inner conductor 80 and the second outer conductor 90 than both the inner overlapping part E1 and the outer overlapping part E2.

In this case, a conductor located on an outermost peripheral side in the inner overlapping part E1 is the second inner conductor tube portion 82 of the second inner conductor 80. Further, a conductor located on an innermost peripheral side in the outer overlapping part E2 is the second outer conductor tube portion 92 of the second outer conductor 90. The first and second dielectrics 42, 72 are not present, but an air layer is present in an annular space between the second inner conductor tube portion 82 and the second outer conductor tube portion 92. Thus, in designing the coaxial connector connection structure 28, the inner overlapping part E1 and the outer overlapping part E2 can be designed to obtain desired communication performance on the premise of the presence of the air layer.

Further, the first inner conductor 50 including the first inner conductor resilient pieces 56 is located in the second inner conductor tube portion 82, and the first outer conductor 60 including the first outer conductor resilient pieces 66 is located outside the second outer conductor tube portion 92. Thus, in designing the coaxial connector connection structure 28, the inner overlapping part E1 and the outer overlapping part E2 can be designed to obtain desired communication performance on the premise of an outer diameter of the second inner conductor tube portion 82 continuously having an equal-diameter part and an outer diameter of the second outer conductor tube portion 92 continuously having an equal-diameter part. Thus, designing is facilitated as compared to designing on the premise of the presence of resilient pieces having a complicated shape.

Further, as described above, the distance L1 between the first coaxial connector 40 and the external connection coaxial connector 30 may possibly vary within a tolerance range.

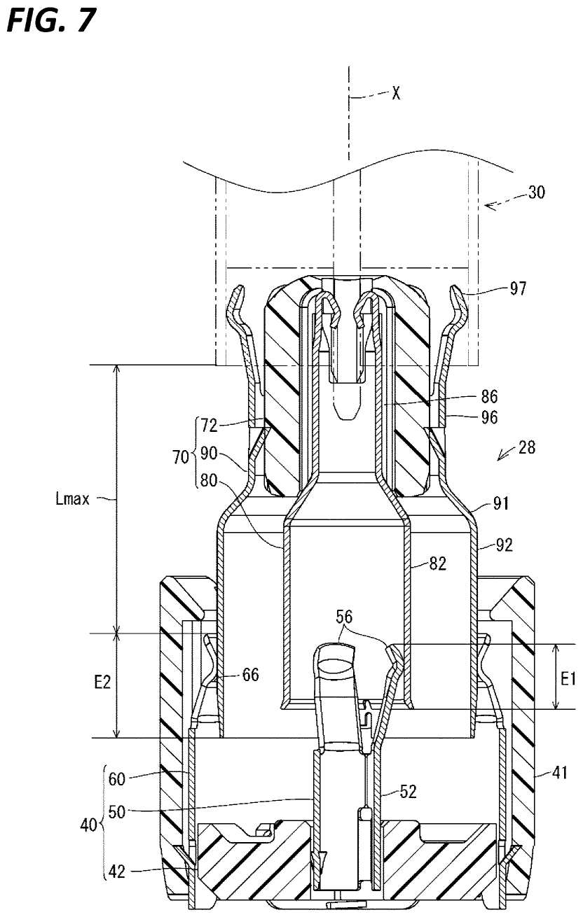

A section when the distance between the first coaxial connector 40 and the external connection coaxial connector 30 becomes longest within the tolerance range and reaches a distance Lmax is shown in FIG. 7.

In this case, a distance between the second inner conductor 80 and the first dielectric 42 increases and a distance between the second outer conductor 90 and the first dielectric 42 also increases. Thus, a region where an air layer is present between the inner and outer conductors becomes larger in the connection structure 28. However, the first and second coaxial connectors 40, 70 are originally designed on the premise of the presence of the air layer between the inner overlapping part E1 and the outer overlapping part E1. Thus, even if a ratio of the air layer increases, it hardly affects communication performance.

In contrast, if a dielectric is arranged between the inner overlapping part E1 and the outer overlapping part E2, the respective connectors are thought to be designed to obtain desired communication performance on the premise of the presence of this dielectric. If an air layer is produced due to position deviations of the connectors on the premise of this design, there is a possibility that communication performance is largely affected.

In this embodiment, since designing is performed on the premise of the presence of the air layer between the inner overlapping part E1 and the outer overlapping part E2, even if the air layer increases in volume, it hardly affects communication performance. Note that, in regions which are away from the inner and outer overlapping parts E1, E2 and where the first and second dielectrics 42, 72 are provided, a diameter and the like of each part are designed to obtain suitable communication performance on the premise of dielectric constants of the first and second dielectrics 42, 72.

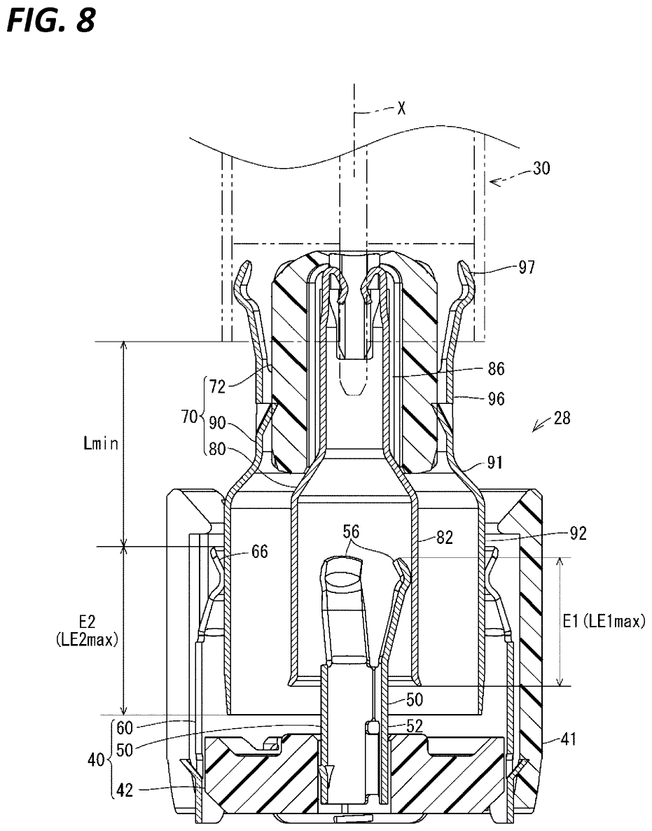

A section when the distance between the first coaxial connector 40 and the external connection coaxial connector 30 becomes shortest within the tolerance range and reaches a distance Lmin is shown in FIG. 8.

In this state, in the direction of the center axis X, a length of the inner overlapping part E1 is an allowable maximum length LE1max and that of the outer overlapping part E2 is an allowable maximum length LE2max. The first and second dielectrics 42, 72 are located to avoid both the inner and outer overlapping parts E1, E2 having reached the allowable maximum lengths LE1max, LE2max so that this state can be established.

To ensure the air layer between the inner and outer overlapping parts E1, E2 and make the air layer larger, the first dielectric 42 is preferably located away from the tip toward the base end side of the first inner conductor tube portion 52 by half the projecting length N of the first inner conductor resilient pieces 56 or more in the direction of the center axis X.

### Effects, Etc.

According to the coaxial connector connection structure 28 configured as described above, the first and second dielectrics 42, 72 are both located to avoid both the inner and outer overlapping parts E1, E2. Thus, the first and second coaxial connectors 40, 70 can be designed to obtain desired communication performance on the premise of the presence of air between the inner and outer overlapping parts E1, E2. In this case, even if the connected position of the second coaxial connector 70 to the first coaxial connector 40 deviates from a predetermined position, only a length of an air present part varies in the connection direction. As compared to the case where each coaxial connector is designed, assuming the presence of a dielectric in most of the inner and outer overlapping parts E1, E2, stable communication performance is obtained.

Further, the first dielectric 42 can keep the first inner conductor 50 and the first outer conductor 60 in a fixed positional relationship at a position closer to the base end side of each of the first inner conductor 50 and the first outer conductor 60 than both the inner and outer overlapping parts E1, E2. The second dielectric 72 can keep the second inner conductor 80 and the second outer conductor 90 in a fixed positional relationship at a position closer to the base end side of each of the second inner conductor 80 and the second outer conductor 90 than both the inner and outer overlapping parts E1, E2. Thus, stable communication performance is easily obtained while the coaxial structure of the connection structure is kept.

Further, it is assumed that the inner and outer overlapping parts E1, E2 reach the allowable maximum lengths LE1max, LE2max if the second coaxial connector 70 is excessively connected to the first coaxial connector 40 within the tolerance range. Even in this case, connection with air present between the inner and outer overlapping parts E1, E2 is realized and stable communication performance is obtained.

Further, since the first dielectric 42 is located away from the tip toward the base end side of the first inner conductor tube portion 52 by half the projecting length N of the first inner conductor resilient pieces 56 or more in the direction of the center axis X, the first dielectric 42 is easily located to avoid the inner and outer overlapping parts E1, E2.

Further, since the second dielectric 72 is separated from the second inner conductor tube portion 82 and the second outer conductor tube portion 92 and arranged between the second inner conductor extended tube portion 86 and the second outer conductor extended tube portion 96, air is easily arranged between the inner and outer overlapping parts E1, E2.

Further, the first inner conductor resilient pieces 56 resiliently contact the inner peripheral surface of the second inner conductor tube portion 82, and the first outer conductor resilient pieces 66 resiliently contact the outer peripheral surface of the second outer conductor tube portion 92. Thus, the presence of the resilient pieces 56, 66 between the second inner conductor tube portion 82 and the second outer conductor tube portion 92 is avoided. In this way, communication performance in the coaxial connector connection structure 28 can be designed on the basis of the second inner conductor tube portion 82 and the second outer conductor tube portion 92, which are easily simplified in shape, and designing can be easily performed. For example, the second inner conductor tube portion 82 and the second outer conductor tube portion 92 can be entirely formed into a hollow cylindrical shape. Further, since the second inner conductor tube portion 82 and the second outer conductor tube portion 92 are constituent parts of the second coaxial connector 70, the positional relationship of the second inner conductor tube portion 82 and the second outer conductor tube portion 92 is easily kept constant. Thus, more stable communication performance is obtained.

Further, the first inner conductor 50 is inserted and fixed in the first dielectric 42 by fitting the positioning piece 53 into the positioning groove 44 with the base end part of the first inner conductor tube portion 52 of the first inner conductor 50 inserted in the insertion hole 43 of the first dielectric 42. Thus, the first inner conductor tube portion 52 is firmly fixed in the first dielectric 42.

For example, even if the first inner conductor 50 is formed by press-working a metal plate, the first inner conductor 50 is easily firmly held by the first dielectric 42. If the first inner conductor 50 is formed by press working, cost can be lower than in the case of formation by cutting.

Further, the retaining projection 53p on the projecting end part of the positioning piece 43 is hooked to the bottom of the positioning groove 44, thereby making the detachment of the first inner conductor 50 from the first dielectric 42 difficult.

Further, since the holding annular protrusion 45 is formed in the part of the first dielectric 42 surrounding the insertion hole 43, even if the first dielectric 42 is formed away from the overlapping parts E1, E2 and, as a result, becomes thin, the first inner conductor 50 is easily firmly held.

Further, the outer peripheral annular protrusion 46 of the first dielectric 42 contacts the first outer conductor 60, whereby the posture of the first outer conductor 60 is easily stabilized with respect to the first dielectric 42. In this way, the positional relationship of the first inner conductor 50 and the first outer conductor 60 is stabilized and communication performance is easily stabilized.

Further, the first coaxial connector 40 is a board side coaxial connector and the second coaxial connector 70 is a relay coaxial connector for relaying the first coaxial connector 40 serving as the board side coaxial connector and the external connection coaxial connector 30. In this case, the position of the second coaxial connector 70 with respect to the first coaxial connector 40 may possibly vary due to a position deviation of the circuit board 21 with respect to the external connection coaxial connector 30. In such a case, stable communication performance is obtained between the first and second coaxial connectors 40, 70.

Note that the respective configurations described in the above embodiment and the respective modifications can be appropriately combined without technically contradicting each other.

### LIST OF REFERENCE NUMERALS

10 device
12 case
13 first case
14 second case
15 bottom portion
16 holding tube portion
17 holding/partitioning portion
17h holding hole
20 electrical component
21 circuit board
22 imaging element
28 connection structure
30 external connection coaxial connector (third coaxial connector)
32 external connection inner conductor
34 external connection dielectric
36 external connection outer conductor
40 first coaxial connector (board side coaxial connector)
41 connector holder
42 first dielectric
43 insertion hole
44 positioning groove
45 holding annular protrusion
46 outer peripheral annular protrusion
50 first inner conductor
52 first inner conductor tube portion
52a locking piece
52b projecting piece
53 positioning piece
53e projecting end part
53p retaining projection
56 first inner conductor resilient piece
56a inclined portion
56b curved portion
60 first outer conductor
62 first outer conductor tube portion
62a locking piece
66 first outer conductor resilient piece
66a inclined portion
66b curved portion
70 second coaxial connector (relay coaxial connector)
72 second dielectric
80 second inner conductor
81 tapered portion
82 second inner conductor tube portion
86 second inner conductor extended tube portion
86a locking piece
87 resilient piece
90 second outer conductor
91 tapered portion
92 second outer conductor tube portion
96 second outer conductor extended tube portion
96a locking piece
97 resilient piece
E1 inner overlapping part
E2 outer overlapping part
LE1max, LE2max allowable maximum length
X center axis

1. A coaxial connector connection structure for connecting a first coaxial connector and a second coaxial connector,
the first coaxial connector including a first inner conductor, a first outer conductor surrounding an outer peripheral side of the first inner conductor and a first dielectric located between the first inner conductor and the first outer conductor,
the second coaxial connector including a second inner conductor, a second outer conductor surrounding an outer peripheral side of the second inner conductor and a second dielectric located between the second inner conductor and the second outer conductor, and
when it is assumed that an overlapping part of the first inner conductor and the second inner conductor in a connection direction of the first coaxial connector and the second coaxial connector is an inner overlapping part and an overlapping part of the first outer conductor and the second outer conductor in the connection direction is an outer overlapping part with the first coaxial connector and the second coaxial connector connected,
both the first dielectric and the second dielectric being located to avoid both the inner overlapping part and the outer overlapping part in the connection direction.

2. The coaxial connector connection structure of claim 1, wherein:
the first dielectric is located closer to a base end side of each of the first inner conductor and the first outer conductor than both the inner overlapping part and the outer overlapping part in the connection direction, and
the second dielectric is located closer to a tip side of each of the second inner conductor and the second outer conductor than both the inner overlapping part and the outer overlapping part in the connection direction.

3. The coaxial connector connection structure of claim 1, wherein:
an allowable maximum length is set in the connection direction for each of the inner overlapping part and the outer overlapping part, and
both the first dielectric and the second dielectric are located to avoid both the inner overlapping part and the outer overlapping part, each having reached the allowable maximum length.

4. The coaxial connector connection structure of claim 1, wherein:
the first inner conductor includes a first inner conductor tube portion and a first inner conductor resilient piece projecting from a tip of the first inner conductor tube portion,
the second inner conductor includes a second inner conductor tube portion to be resiliently contacted by the first inner conductor resilient piece,
the first dielectric surrounds a base end side part of the first inner conductor tube portion, and
the first dielectric is located away from the tip of the first inner conductor tube portion toward a base end side of the first inner conductor tube portion by half the projecting length of the first inner conductor resilient piece or more in the connection direction.

5. The coaxial connector connection structure of claim 1 wherein:
the second inner conductor includes a second inner conductor tube portion and a second inner conductor extended tube portion,
the second outer conductor includes a second outer conductor tube portion and a second outer conductor extended tube portion,
the second inner conductor tube portion is a part to be connected to the first inner conductor,
the second outer conductor tube portion is a part to be connected to the first outer conductor,
the second outer conductor tube portion is coaxially arranged around the second inner conductor tube portion, and
the second dielectric is arranged between the second inner conductor extended tube portion and the second outer conductor extended tube portion while avoiding a gap between the second inner conductor tube portion and the second outer conductor tube portion in the connection direction.

6. The coaxial connector connection structure of claim 1 wherein:
the first inner conductor includes a first inner conductor tube portion and a first inner conductor resilient piece projecting from a tip of the first inner conductor tube portion,
the first outer conductor includes a first outer conductor tube portion and a first outer conductor resilient piece projecting from a tip of the first outer conductor tube portion,
the second inner conductor includes a second inner conductor tube portion to be resiliently contacted by the first inner conductor resilient piece,
the second outer conductor includes a second outer conductor tube portion to be resiliently contacted by the first outer conductor resilient piece,
the first inner conductor resilient piece resiliently contacts an inner peripheral surface of the second inner conductor tube portion, and
the first outer conductor resilient piece resiliently contacts an outer peripheral surface of the second outer conductor tube portion.

7. The coaxial connector connection structure of claim 1, wherein:
the first inner conductor includes a positioning piece projecting to an outer peripheral side from an outer peripheral surface of a base end part of the first inner conductor and extending along a center axis of the first inner conductor,
the first dielectric is formed with an insertion hole, the base end part of the first inner conductor being inserted into the insertion hole, and a positioning groove, the positioning piece being fit into the positioning groove, and
the first inner conductor is inserted and fixed in the first dielectric by fitting the positioning piece into the positioning groove with the base end part of the first inner conductor inserted in the insertion hole.

8. The coaxial connector connection structure of claim 7, wherein a retaining projection to be hooked to the first dielectric inside the positioning groove is formed on a projecting end part of the positioning piece.

9. The coaxial connector connection structure of claim 7, wherein a holding annular protrusion annularly projecting toward a tip side of the first inner conductor is formed in a part of the first dielectric surrounding the insertion hole.

10. The coaxial connector connection structure of claim 7, wherein an outer peripheral annular protrusion annularly projecting toward a tip side of the first inner conductor is formed on an outer peripheral part of the first dielectric on the first outer conductor side.

11. The coaxial connector connection structure of claim 1, wherein:
the first coaxial connector is a board side coaxial connector to be fixed to a circuit board, and
the second coaxial connector is a relay coaxial connector for relaying and connecting the first coaxial connector and a third coaxial connector.
